(19) United States
(12) Patent Application Publication
(10) Pub. No.: US 2012/0048060 A1
(43) Pub. Date: Mar. 1, 2012

(54) Bicycle Pedal

(75) Inventor: Franc ARNOLD, Koblenz (DE)

(73) Assignee: RTI SPORTS VERTRIEB VON SPORTARTIKELN GMBH, Koblenz (DE)

(21) Appl. No.: 13/222,731

(22) Filed: Aug. 31, 2011

(30) Foreign Application Priority Data
Aug. 31, 2010 (DE) 202010012045.4

(51) Int. Cl. B62M 3/08

(52) U.S. Cl. 74/594.4

(57) ABSTRACT

A bicycle pedal, particularly for touring bicycles, comprises a pedal body (10) made of plastic material. In the pedal body (10), an axis opening (20) is provided for accommodating a pedal axis (24). The pedal axis (24) is surrounded by a sleeve (22). At least one bearing element (26,28), being formed as a slide bearing, is arranged between the pedal axis (24) and the sleeve (22).

### BACKGROUND OF THE INVENTION

1. Field of the Invention

The present invention relates to a bicycle pedal, particularly for touring bicycles.

2. Description of the Prior Art

Bicycle pedals comprise a pedal body whereon a foot support surface is formed for force transmission. Particularly sports bicycles are frequently equipped with so-called “click pedals”. For use with click pedals, it is required for the cyclist to wear corresponding shoes which are provided with locking elements on their soles. Although click pedals have a relatively low weight, they entail the disadvantage that the cyclist will have to wear special shoes which are useful only to a limited extent in situations other than cycling, particularly for walking. As a consequence, click pedals are only rarely used in touring bicycles.

Conventional pedals with foot support surface have a relatively high weight. For weight reduction, pedals are known wherein the pedal body is made of a plastic material. Pedal bodies of a plastic material, however, have the disadvantage that plastic, as a result of the shrinkage process occurring in manufacture, has relatively high tolerances. For this reason, support of pedal bodies of plastic on the pedal axis is realized by two ball bearings, each of them comprising an inner bearing ring and an outer bearing ring. For taking up axial forces, one of the two bearings can be designed e.g. as an angular contact ball bearing. The provision of ball bearings, on the other hand, has the disadvantage that these are relatively heavy and require considerable expenditure for mounting. Further, ball bearings have a large constructional size. This has the consequence that, due to a required minimum thickness of the plastic for reasons of stability, the pedal bodies are relatively voluminous. Thus, in such pedals, the foot support surface has a relatively large distance to the center line of the pedal axis. This in turn causes the disadvantage that the distance between the bottom bracket axis and the foot support surface will considerably vary during the pedaling movement so that the movement of the foot will differ relatively strongly from an ideal circular movement.

It is an object of the invention to provide a bicycle pedal allowing the use of a pedal body made of plastic material wherein said bicycle pedal has an improved support.

### SUMMARY OF THE INVENTION

According to the present invention, the above object is achieved by the features defined in claim 1.

The bicycle pedal of the invention, which is suited particularly for touring bicycles and the like, comprises a pedal body made of plastic material. Said pedal body forms a foot support surface, wherein, particularly, two foot support surfaces are arranged on opposite sides from each other. The pedal body is provided with an axis opening in which a pedal axis is arranged. According to the invention, said pedal axis is surrounded by a sleeve. The bearing elements are arranged between said sleeve and the pedal axis, there being provided at least one bearing element. According to the invention, said at least one bearing element is designed as slide bearing. Preferably, there are provided two bearing elements, notably an outer bearing element arranged on a free end in the pedal axis, and an inner bearing element. In the mounted state of the bicycle pedal, said inner bearing element is disposed on the inward side, i.e. in the direction of the connection element connecting the pedal axis with the pedal crank. Preferably, both bearing elements are formed as slide bearings. According to a preferred embodiment, said sleeve surrounding the pedal axis does not extend along the whole length of the pedal axis but only along the region in which the two bearing elements are arranged.

To begin with, the use of pedal bodies of plastic material has the disadvantage that, as a result of the shrinkage process during the manufacturing process, there will be caused relatively large tolerances. This has the consequence that bicycle pedals with pedal bodies made of plastic are not provided with slide bearings but with ball bearings. An essential feature of the invention is the combination of slide bearings and a sleeve surrounding the pedal axis. It is surprising that, in spite of the provision of a sleeve, said combination of slide bearings and a sleeve will require less constructional space than ball bearings. Since, according to a preferred embodiment, there is provided a sleeve having a relatively small wall thickness of preferably less than 3 mm and more preferably less than 2 mm, it is rendered possible to realize a very small constructional space requirement and, at the same the same time, a low weight.

According to a preferred embodiment of the invention, at least the outer bearing element, arranged at a free end of the pedal axis, is formed as a slide bearing. The outer bearing element is to be understood herein as the bearing element which in the mounted state is arranged in an outer position relative to the pedal crank. Preferably, also the inner bearing element, arranged closer to the pedal crank, is formed as slide bearing.

To realize a pedal body designed with the best possible ergonomics, it is preferred that the foot support surface is of a sloping orientation in an outward direction, i.e. away from the pedal crank. In this manner, it is made possible to design a pedal body with a so-called “Varus wedge”. With respect to the orientation of the foot, this has considerable ergonomic advantages. However, this can be realized only by an outwardly tapering pedal body. Further, the requirement exists that the pedal body should have a smallest possible constructional height also on its inward side. Thus, according to a particularly preferred embodiment of the invention, the pedal axis is designed to have a smaller diameter in the region of the outer bearing element than in the region of the inner bearing element. This is to say that the pedal axis is tapered in an outward direction. This has the advantage that an outer bearing element with a smaller outer diameter can be used. Thereby, one can realize a pedal body with Varus wedge function which also has a low constructional height at the inward side of the pedal. Preferably, the outer bearing element has a smaller inner diameter and preferably also a smaller outer diameter than the inner bearing element. According to the invention, it is preferred that the inner bearing element is larger so as to guarantee a sufficient force take-up of the bearings. Thereby, the useful life of the bearing elements, which are designed particularly as slide bearings, is extended.

According to a preferred embodiment, one of the two bearing elements, preferably the inner bearing element, is configured as a radial and axial bearing. Since preferably also the inner bearing element is formed as a slide bearing, it is preferred that this bearing is provided with an axial abutment portion. If the slide bearing is formed as a hollow cylinder, said axial abutment portion is realized as an annular shoulder. Designing the inner bearing element additionally as an axial bearing has the advantage that the outer bearing element can be designed as a pure radial bearing and thus can be small-sized. Via a tensioning element provided on the free outer end of the pedal axis, the two bearing elements can be tensioned. For this purpose, said tensioning element preferably comprises a nut to be screwed onto a bearing pin, wherein, for generating a defined biasing force, a spring element such as e.g. a plate spring, can be provided between said nut and the outer bearing element. To effect a biasing of the bearings in a simple manner, it is provided, according to a preferred embodiment, that said axial abutment of the inner bearing element is arranged between a shoulder of the pedal axis and an end face of the sleeve. Thus, said axial abutment runs against an end face of the sleeve.

According to a particularly preferred embodiment of the invention, the sleeve is provided with a twist protection means on its outward side. Said twist protection means can be realized e.g. by longitudinal grooves which are provided on the outward side of the sleeve particularly in the region of the inner bearing element. Thereby, undesired twisting of the sleeve within the pedal body during the process of mounting the pedal axis, particularly when tensioning the bearings, is reliably prevented. It is further safeguarded thereby that a twisting movement of the sleeve in the pedal body is prevented during operation. Since such a twist protection means does not necessarily have to be provided along the entire length of the sleeve, it is preferred that the sleeve has a smaller outer diameter in its outer region facing away from the pedal crank than in its region located in the area of the inner bearing element. This can be realized in that no twist protection means is provided in the outer region of the sleeve. Advantageously, this allows for a further reduction of the required constructional space in the region of the outer bearing element, thus making it possible to realize an axis body serving as a Varus wedge and, at the same time, to achieve a relatively small constructional height on the inward side.

Since slide bearings are very sensitive to dust and dirt, it is preferred to provide a dust seal between the pedal axis and the pedal body. Said dust seal, preferably formed as a radial shaft sealing ring, is preferably arranged in the region of the axis entrance opening.

Manufacture of the bicycle pedal of the invention is preferably performed in the following manner. The sleeve will be placed in an injection mold and then will be enclosed, through injection molding, by the plastic material forming the pedal body. Since it is desired to realize the narrowest possible tolerances for the slide bearings, it is provided that the inner surface of the sleeve, after the pedal body has been injection-molded around it, will be treated, preferably milled, in the region of the bearing elements. Then, the pedal axis will be mounted. The slide bearings can already have been premounted on the pedal axis so that the pedal axis can be inserted via the axis opening of the pedal body and thus into the sleeve arranged within the pedal body. Preferably, this will be performed already together with the installation of said radial shaft sealing ring serving for dust protection. The fixing of the pedal axis and the axial biasing of the bearings are preferably performed via a mounting opening provided on the outward side of the pedal body for introducing therethrough the individual component parts of the tensioning elements. Thus, via the mounting opening, e.g. a plate spring and a compensating disk will be mounted onto a pin of the pedal axis and then be secured by a nut which will be screwed onto said pin of the pedal axis. Then, the mounting opening can be closed by a lid for preventing ingress of dirt or dust.

### BRIEF DESCRIPTION OF THE DRAWINGS

A full and enabling disclosure of the present invention, including the best mode thereof, enabling one of ordinary skill in the art to carry out the invention, is set forth in greater detail in the following description, including reference to the accompanying drawing in which

FIG. 1 is a schematic sectional view of a preferred embodiment of the bicycle pedal of the invention, and

FIG. 2 is a schematic perspective view of the sleeve.

### DESCRIPTION OF PREFERRED EMBODIMENTS OF THE INVENTION

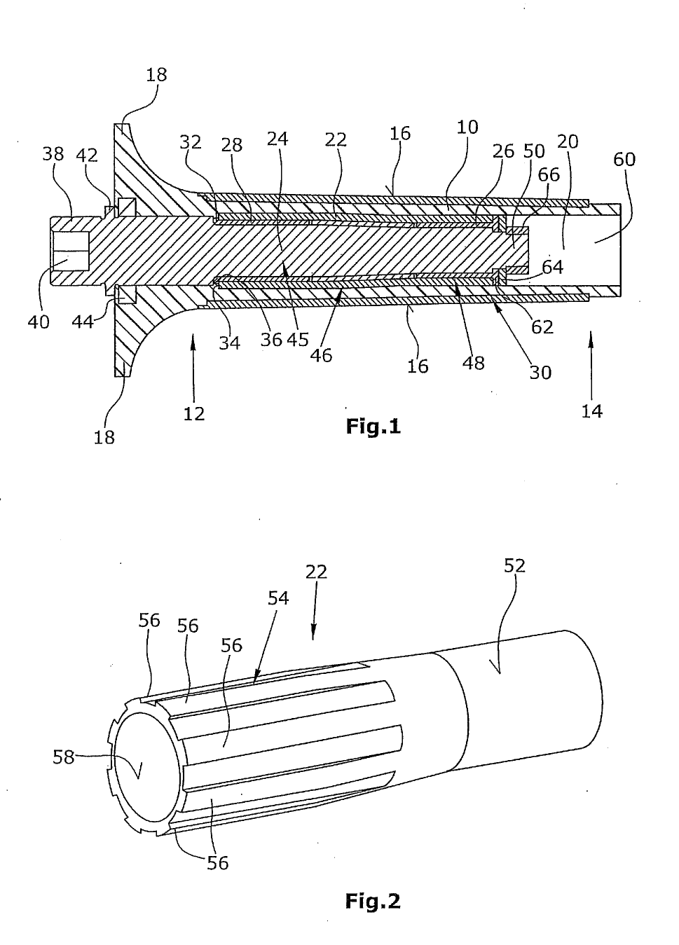

The bicycle pedal of the invention comprises a pedal body 10 made of a plastic material. Said pedal body 10 is preferably of such an ergonomic design that, corresponding to the function of a Varus wedge, it has a larger height on an inward side 12 thereof than on an outward side 14 thereof. The pedal body is thus tapered outwardly, i.e. to the right-hand side in FIG. 1. Accordingly, the pedal body forms two mutually opposite foot support surfaces 16 formed with an outward slope. On an inner side of pedal body 10 which is pointing toward a pedal crank, not shown, an inner abutment portion 18 is provided (left-hand side in FIG. 1). Due to the inner abutment portion 18, the foot can be displaced inwardly with a risk of contacting the pedal crank.

The pedal body 10 comprises an axis opening 20 which in the illustrated embodiment is a throughgoing opening. In said axis opening 20, a sleeve 22 is arranged. Said sleeve 22 serves for accommodating a pedal axis 24. For bearing support of the pedal, an outer bearing element 26 and an inner bearing element 28 are arranged between pedal axis 24 and sleeve 22. Both bearing elements 26,28 are designed as slide bearings.

Said outer bearing element 26, provided in the region of a free end 30 of pedal axis 24, is designed as a pure axial bearing. Thus, this bearing is a slide bearing having the shape of a hollow cylinder. The inner and outer diameters of the outer slide bearing 26 are smaller than the inner and outer diameters of the inner slide bearing 28. Further, the inner slide bearing 28 is formed as an axial bearing. For this purpose, the cylindrical portion of inner slide bearing 28 is connected to a radially outward axial stop portion 32. Said axial stop portion 32 is in abutment against an end face 34 of sleeve 22 on the one hand and against a shoulder 36 of pedal axis 24 on the other hand.

Pedal axis 24 comprises a projection 38 provided with an outer thread. With the aid of said projection 38, the pedal axis will be screwed into the pedal crank. For this purpose, there is further provided a hexagon socket 40 in said projection 38. In the longitudinal direction of pedal axis 24, projection 38 is followed by an annular projection 42 serving for abutment of pedal body 10 thereon. Within projection 42, a radial shaft seal ring 44 is arranged for sealing the bearing elements 26,28 against dust. Behind said shoulder 36, the surface of the shaft is cylindrical, and the surface is formed as a bearing seat for mounting the slide bearing 28. In the region 46 of pedal axis 24 following therebehind, pedal axis 24 tapers toward the free end 30. This conical region 46 in turn is followed by a cylindrical region 48. The surface of said region 48 has been treated for allowing it to accommodate the slide bearing 26, wherein said region 48 has a smaller diameter than the region 45 serving for accommodating the inner bearing element 26. Region 48 is followed by a shaft pin 50 with outer thread.

Said shell 22 (FIG. 2) arranged within pedal body 10 has a smaller outer diameter in the region of the outer slide bearing element 26 than in the region of the inner bearing element 28. In an outer cylindrical region 52 (FIG. 22), sleeve 22 has an outer diameter of e.g. 13 mm. In an inner region 54, sleeve 22 then has an outer diameter of e.g. 14 mm. Said two regions merge into each other in a conical region.

Further, in the region of inner bearing element 28, sleeve 22 comprises projections 56 extending in the longitudinal direction, thus forming longitudinal grooves. In this manner, a twist protection means is realized. For manufacturing the bicycle pedal, sleeve 22 will be placed in an injection mold and be enclosed by plastic material by injection-molding the material around the sleeve. In a next working step, the interior surface 58 of sleeve 22 will be subjected to a surface treatment in the region of the two slide bearings 26,28. Then, the pedal axis 24 will be introduced, while the slide bearings 26,28 and also the radial shaft sealing ring 44 have already been premounted on the pedal axis 24. For fixing the pedal axis 24 in the pedal body 10 and for biasing the bearings, a plate spring 62 and a compensating disk 64 will first be mounted to the shaft pin 50 via a mounting opening 60 (FIG. 1). Then, a nut 66 will be screwed onto shaft pin 50. Said mounting opening 60 can then be closed by a lid in a dust-proof manner.

Although the invention has been described and illustrated with reference to specific illustrative embodiments thereof, it is not intended that the invention be limited to those illustrative embodiments. Those skilled in the art will recognize that variations and modifications can be made without departing from the true scope of the invention as defined by the claims that follow. It is therefore intended to include within the invention all such variations and modifications as fall within the scope of the appended claims and equivalents thereof.

1. A bicycle pedal, particularly for touring bicycles, comprising
a pedal body made of plastic material,
an axis opening provided in said pedal body for accommodating a pedal axis,
a sleeve surrounding said pedal axis, and
at least one slide bearing element arranged between said pedal axis and said sleeve, said at least one slide bearing element being formed as a slide bearing.

2. The bicycle pedal, particularly for touring bicycles, according to claim 1, wherein an outer bearing element arranged at a free end of the pedal axis, is formed as a slide bearing.

3. The bicycle pedal, particularly for touring bicycles, according to claim 1, wherein an inner bearing element is provided which is formed as slide bearing.

4. The bicycle pedal, particularly for touring bicycles, according to claim 1, wherein the pedal axis is tapered in the region of the outer bearing element.

5. The bicycle pedal, particularly for touring bicycles, according to claim 1, wherein the outer bearing element has a smaller inner diameter and preferably also a smaller outer diameter than the inner bearing element.

6. The bicycle pedal, particularly for touring bicycles, according to claim 1, wherein the inner bearing element is configured as a radial and axial bearing, preferably being provided with an axial abutment portion.

7. The bicycle pedal, particularly for touring bicycles, according to claim 1, wherein the sleeve is provided with a twist protection means on an outward side, preferably in the region of the inner bearing element.

8. The bicycle pedal, particularly for touring bicycles, according to claim 1, wherein the sleeve has a smaller outer diameter in the region of the outer bearing element than in the region of the inner bearing element.

9. The bicycle pedal, particularly for touring bicycles, according to claim 6, wherein said axial abutment portion of the inner bearing element is arranged between an end face of the sleeve and a shoulder of the pedal axis.

10. The bicycle pedal, particularly for touring bicycles, according to claim 1, wherein a tensioning element is provided on the free outer end of the pedal axis for fixing and biasing the bearing elements.

11. The bicycle pedal, particularly for touring bicycles, according to claim 1, wherein, at least in the region of the pedal axis, the pedal body is tapered outward.

12. The bicycle pedal, particularly for touring bicycles, according to claim 1, wherein a dust seal surrounding the pedal axis is provided between the pedal axis and the pedal body, preferably in the region of an axis entrance opening of the pedal body.
